(19) United States
(12) Patent Application Publication
(10) Pub. No.: US 2013/0166887 A1
(43) Pub. Date: Jun. 27, 2013

(54) DATA PROCESSING APPARATUS AND DATA PROCESSING METHOD

(71) Applicant: Ryuji Sakai, Hanno-shi (JP)

(72) Inventor: Ryuji Sakai, Hanno-shi (JP)

(21) Appl. No.: 13/587,688

(22) Filed: Aug. 16, 2012

(30) Foreign Application Priority Data
Dec. 27, 2011 (JP) 2011-285496

(51) Int. Cl. G06F 9/38

(52) U.S. Cl. 712/220; 712/E09.045

(57) ABSTRACT

According to one embodiment, a data processing apparatus includes a processor and a memory. The processor includes core blocks. The memory stores a command queue and task management structure data. The command queue stores a series of kernel functions. The task management structure data defines an order of execution of kernel functions by associating a return value of a previous kernel function with an argument of a subsequent kernel function. Core blocks of the processor are capable of executing different kernel functions.

### CROSS-REFERENCE TO RELATED APPLICATIONS

This application is based upon and claims the benefit of priority from Japanese Patent Application No. 2011-285496, filed Dec. 27, 2011, the entire contents of which are incorporated herein by reference.

### FIELD

Embodiments described herein relate generally to a data processing apparatus and a data processing method for performing parallel processing.

### BACKGROUND

In recent years, multi-core processors, in which a plurality of cores exist in one processor and a plurality of processes are performed in parallel, have been commercially available. Multi-core processors are often used in graphics processing units (GPUs) for image processing, which require a large amount of computations.

In conventional parallel processing of data processing apparatuses such as GPUs, the single process multiple data, or single program multiple data (SPMD) model is generally employed. The SPMD model is a form of computing a large amount of data in one instruction sequence (program). Accordingly, parallel processing in the SPMD model is also called data parallel computing.

In order to perform parallel data processing in the SPMD model, large-scale data is located in a device memory that can be accessed by a data processing apparatus, and a function called a kernel, designed to perform a computation of one data element, is entered into a queue of the data processing apparatus as the size of the data is specified. This allows a large number of cores in the data processing apparatus to perform parallel processing simultaneously. A kernel defines an application programming interface (API), which is designed to obtain an ID (such as a pixel address) for specifying data to be computed by the kernel. Based on the ID, the kernel accesses the data to be computed by the kernel, performs processing such as computation, and writes the result into a predetermined area. The ID has a hierarchical structure, in which the relation:

Global ID=Block ID×Number of local Threads+Local ID

is satisfied.

Since data processing apparatuses capable of executing a plurality of instruction sequences for each block have been developed, it has become possible to execute a plurality of instruction sequences simultaneously. A proposed mechanism utilizing this function is to enter a kernel, into which a plurality of kernels are merged, into a queue and perform a separate process based on a block ID, thereby performing a plurality of different tasks in parallel simultaneously. Such parallel processing is called parallel task processing. This is a form of multitasking considering the characteristics that the same instruction must be executed in a block of a data processing apparatus to prevent degradation in performance, but different instruction sequences can be executed in different blocks without greatly affecting the performance.

In the above-described parallel task processing, there is a problem that the occupancy of the CPU is reduced until the next kernel is executed if the execution times of kernel functions executed simultaneously are not the same. In order to solve this problem, a mechanism has been proposed for queueing a task to a device memory from a host processor and thereby obtaining the next task and executing a corresponding kernel function. There is also an approach of queueing a new task to a queue on a device memory according to the development of processing of a data processing apparatus.

In general, in the case of simple parallel data processing, the SPMD model is enough. But when the parallelism is of the order of single or double digits, the computing function of the conventional data processing apparatus cannot be fully utilized in the SPMD model. To address this, there is an approach of executing a plurality of different tasks using the multiple process multiple data, or multiple program multiple data (MPMD) model of parallel task processing. When a plurality of tasks are executed in the MPMD model, however, it requires a lot of labor and easily causes bugs to code a program to enter a process into one execution queue while maintaining the sequence of the order of execution of the tasks. In particular, it is difficult to identify the problem that has caused an error in execution timing, and in some cases, a problem appears a little while after the system operation is started. In order to achieve parallelism of a sufficiently high order in the MPMD model of parallel task processing, great restrictions will be imposed on programs to be implemented in parallel task processing. As a result, only the parallelism of a level equal to that of the SPMD model of parallel data processing can be generally obtained.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an exemplary view of a configuration of an overall system according to an embodiment.

FIG. 2 shows another exemplary view of the configuration of the overall system according to the embodiment.

FIG. 3 shows an exemplary view showing an outline of parallel processing according to the embodiment.

FIG. 4 shows an exemplary flowchart illustrating parallel processing according to the embodiment.

### DETAILED DESCRIPTION

Various embodiments will be described hereinafter with reference to the accompanying drawings.

In general, according to one embodiment, a data processing apparatus includes a processor and a memory connected to the processor. The processor includes a plurality of core blocks. The memory stores a command queue and task management structure data. The command queue stores a series of kernel functions formed by combining a plurality of kernel functions. The task management structure data defines an order of execution of kernel functions by associating a return value of a previous kernel function with an argument of a subsequent kernel function. Core blocks of the processor are capable of executing different kernel functions.

Hereinafter, the first embodiment will be described with reference to the accompanying drawings.

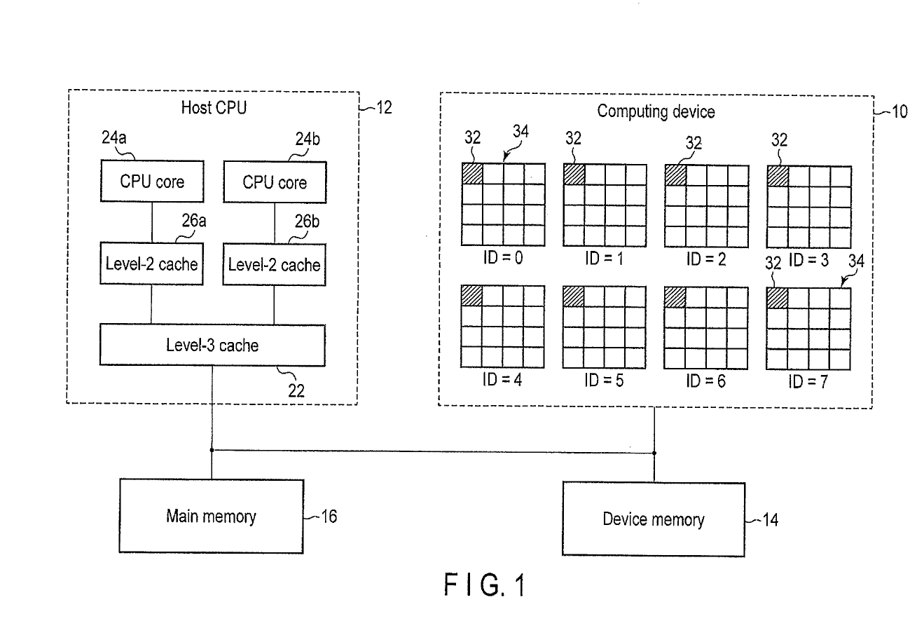

FIG. 1 shows an example of a configuration of an overall system according to the embodiment. For example, a computing device 10, which is a GPU, for example, is controlled by a host CPU 12. The computing device 10 is formed of a multi-core processor, and is divided into a large number of core blocks. In the example of FIG. 1, the computing device 10 is divided into 8 core blocks 34. The computing device 10 is capable of managing a separate context for each core block 34. Each of the core blocks is formed of 16 cores. By operating the core blocks or the cores in parallel, high-speed parallel task processing is achieved.

The core blocks 34 are identified by block IDs, which are 0-7 in the example of FIG. 1. The 16 cores in a block are identified by local IDs, which are 0-15. The core with local ID 0 is referred to as a representative core 32 of the block.

The host CPU 12 may also be a multi-core processor. In the example of FIG. 1, the host CPU 12 is configured as a dual-core processor. The host CPU 12 has a three-level cache memory hierarchy. A level-3 cache 22, connected to a main memory 16, is provided in the host CPU 12, and is connected to level-2 caches 26a, 26b. The level-2 caches 26a, 26b are connected to CPU cores 24a, 24b, respectively. Each of the level-3 cache 22 and the level-2 caches 26a, 26b has a hardware-based synchronization mechanism, and performs synchronous processing necessary for accessing the same address. The level-2 caches 26a, 26b hold data on an address to be referred to in the level-3 cache 22. When a cache error occurs, for example, necessary synchronous processing is performed between the level-2 caches 26a, 26b and the main memory 16 using the hardware-based synchronization mechanism.

A device memory 14, which can be accessed by the computing device 10, is connected to the computing device 10, and the main memory 16 is connected to the host CPU 12. Since the two memories, the main memory 16 and the device memory 14 are connected, data is copied (synchronized) between the device memory 14 and the main memory 16 before or after a process is performed in the computing device 10. For that purpose, the main memory 16 and the device memory 14 are connected to each other. When a plurality of processes are performed in succession, however, the data does not need to be copied every time a process is performed.

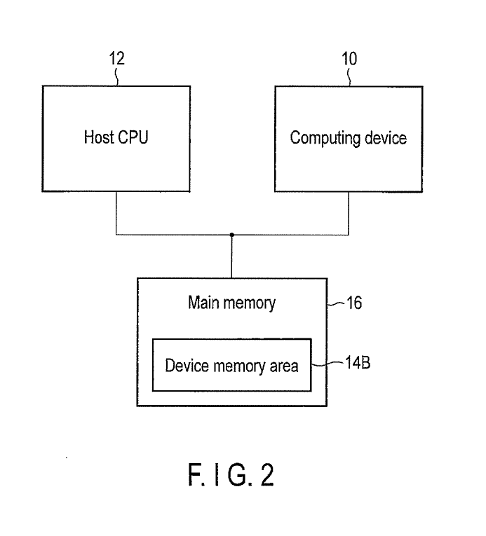

FIG. 2 shows another example of a system configuration. In this example, instead of providing the device memory 14 independently, a device memory area 14B equivalent to the device memory 14 of FIG. 1 is provided in the main memory 16, such that the computing device 10 and the host CPU 12 share the main memory 16. In this case, data does not need to be copied between the device memory and the main memory.

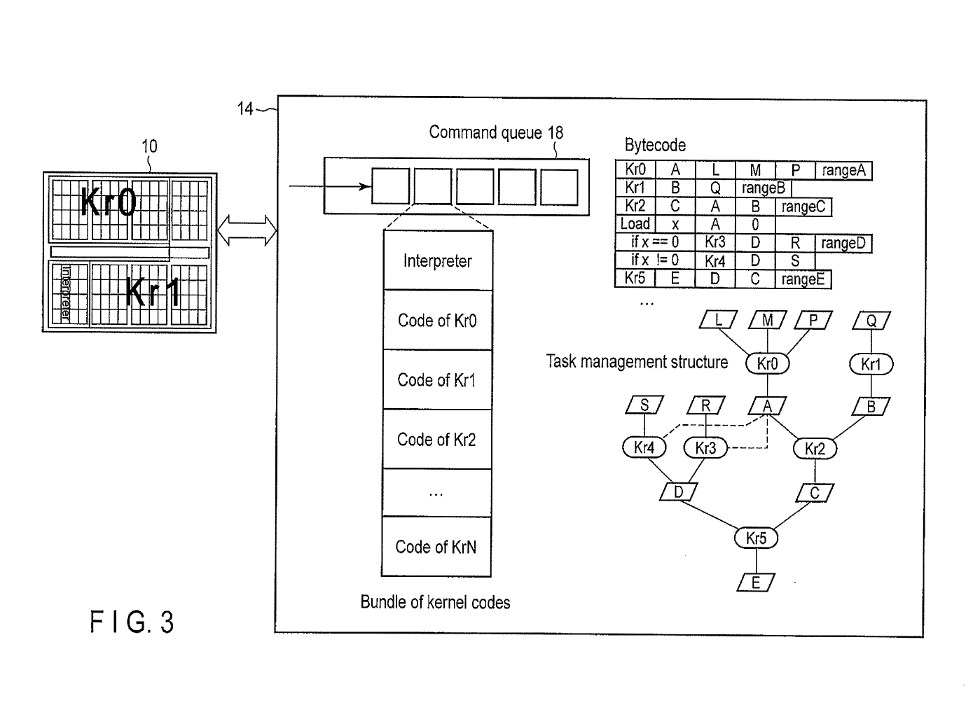

FIG. 3 shows an outline of parallel processing. A program (parallel code) for executing a plurality of kernels in parallel is written in a dataflow language, as shown below. In this example, an “if statement” is implemented, which is formed of a calling sequence of kernel functions Kr0, Kr1, Kr2, Kr3, Kr4, and Kr5, which order is defined by arguments and return values. The kernel function to be called is switched between Kr3 and Kr4 according to the value of A[0].

A=Kr0(L, M, P);

B=Kr1(Q);

C=Kr2(A, B);

if (A[0]==0)
D=Kr3(R);

Else
D=Kr4(S);

E=Kr5(D, C);

The bytecode shown in FIG. 3 is an example in which the above-described parallel code is compiled, and the bytecode is transferred to the device memory 10. The bytecode for kernel function Kr0 is 6 bytes. The bytecode is interpreted and executed by an interpreter. The bytecode is machine-independent, and can be processed in parallel seamlessly even in a computing device with a different architecture. Kernels, for each of which computing of one data element is executed in the computing device 10, are combined into a bundle of kernel codes, which is then entered into a command queue 18 provided in the device memory 14. The kernel code Kr0 is the substance of kernel function Kr0, i.e., the main part (such as multiplication of matrices and the inner product of vectors) of a computer program to be executed on the computing device. The bytecode is a program for executing a procedure for allocating the kernel functions into blocks of the computing device and performing the kernel functions. The bundle of kernel codes is one instruction sequence (program), and the parallel processing shown in FIG. 3 is parallel data processing based on the SPMD model. An interpreter program is placed in an entry address of the bundle of kernel codes.

A task management structure (graph structure) is also stored in the device memory 14. The task management structure is generated by the computing device 10 based on the bytecode, and represents the sequence in which the kernel functions are executed by associating a return value of the previous kernel function with an argument of the subsequent kernel function. This makes it possible to represent the data flow of the original parallel algorithm in a natural manner, and to extract the maximum parallelism during program execution.

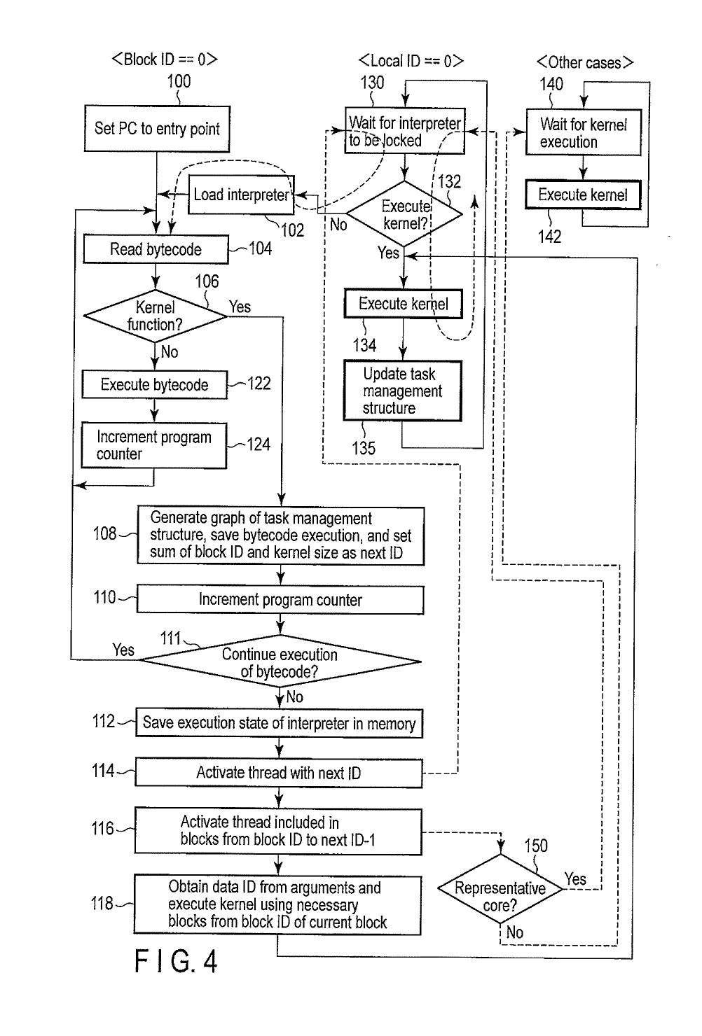

FIG. 4 shows a flowchart of an example of parallel processing performed on the computing device 10. The processing sequence varies according to which of the cores of the computing device 10 the processing is performed. In FIG. 4, the sequence at the left is for the representative core 32 of the core block 34 with block ID=0, the sequence at the center is for the representative cores 32 of the core blocks 34 with block IDs other than 0 (i.e., 1-7), and the sequence at the right is for the cores other than the representative cores 32. The representative cores 32 of the core blocks alternately execute the code of the interpreter.

The representative core 32 of the core block 34 with block ID=0 sets a program counter to an entry point in block 100. That is, the entry point is set at a position of the bytecode for kernel function Kr0.

The representative core 32 of the core block 34 with block ID=0 reads the bytecode according to the program counter in block 104. In this example, “Kr0, A, I, M, P, and range A” are read as the bytecodes for kernel function Kr0.

It is determined in block 106 whether the read bytecode is a kernel function or not. If the read bytecode is a kernel function, in block 108, a task management structure (see FIG. 3) for the kernel function is generated on the device memory 14 and tasks are allocated to the blocks. The tasks may be allocated in the task management structure for each block. After that, execution of the bytecode is saved, and the sum of the block ID (0 in this example) and a block size (3 in this example, based on the number of arguments I, M and P, which data is obtained from the operand “range A” of the bytecode) necessary for executing the kernel function is set as the next ID, thereby securing the number (=3) of core blocks necessary for executing kernel function Kr0. Incrementation of the bytecode is executed in block 124 or block 110. In this case, the incrementation size is the size (6 bytes, in the case of the first instruction) of the bytecode currently being executed. Three core blocks with block IDs=0-3 are allocated to kernel function Kr0. The task management structure controls the order of execution of the tasks, and performs a series of processing on the device memory. The task management structure has a queue or a graph structure in order to secure the order of execution of the tasks. In this example, a graph structure is employed. Execution control can be performed “in order” in the case of a queue structure, and can be performed “out of order” in the case of a graph structure. In other words, in the queue structure, the order of starting tasks can be controlled only in the order in which the tasks are placed in the queue, but in the graph structure, the processing can be started by allocating blocks in sequence, starting from a task that is ready to be executed, even if the task is registered afterwards.

In block 110, the program counter is incremented (+1), and is set to the address of the next instruction (position of the bytecode for kernel function Kr1).

In block 112, the execution state (context) of the interpreter is saved on the memory.

In block 114, a thread of the next ID is activated. A thread ID, a block ID, a local ID, and a block size will now be described. The thread ID is also called as the Global ID. In OpenCL, a block is referred to as a work group. In general, a thread size is specified in execution of a kernel on a computing device. Threads of a number corresponding to the thread size are activated. In the example shown, assume that 16×8=128 threads are activated. In this case, thread IDs 0-127 are assigned to the 128 threads. The first 16 threads, i.e., threads with IDs 0-15, are started to be executed in the block with block ID=0, and the next 16 threads, i.e., threads with IDs 16-31 are started to be executed in the block with block ID=1. The threads with IDs 16-31 have local IDs 0-15 and a block size of 16. In this case, the relation:

Thread ID (or Global ID)=block ID×block size+local ID

is satisfied.

The thread referred to a representative core is a thread with local ID 0.

The thread with the next ID is the thread with thread ID of 16×3=48.

In block 116, the threads included in the blocks with the IDs from the block ID of the current block to (next ID−1) are activated, and the processing of the interpreter is inherited to the representative core 32 of the core block in which the block ID is the next ID (3 in this example).

In block 118, a data ID is obtained from arguments (L, M and P), and the processing of kernel function Kr0 is executed using core blocks of a necessary number (=3) from the block ID of the current block.

After block 116, it is determined in block 150 whether the local ID is 0 (representative core) or not. When the local ID is 0 (representative core), it is waited until the interpreter is locked in block 130, and it is determined whether the kernel function is ready to be executed (whether all the data on the arguments has been computed) or not in block 132. When the kernel function is ready to be executed, the kernel function is executed in block 134. After that, the procedure returns to block 130.

When the kernel function is not ready to be executed, the procedure returns to block 102, and the interpreter is loaded.

The representative core of the subsequent core block (with block ID=3 in this example) that has inherited the processing of the interpreter in block 116 continues execution of interpretation of the bytecode, and, when a kernel function (kernel function Kr1 in this example) that can be executed is found, adds data to the task management structure as in the first representative core, secures a necessary block, inherits the interpreter processing to the next representative core, and shifts to execution of kernel function Kr1 (block 134).

In block 111, it is determined whether to continue execution of the bytecode corresponding to the kernel function. When the execution is continued (the execution can be performed), the procedure returns to block 104. When the execution cannot be performed (i.e., not all the data on the arguments has been computed), data necessary for the task management structure is added and execution of the bytecode is continued.

After execution of the kernel function (block 134) is completed, the representative core that has been activated first updates the data on the task management structure in block 135, and when a kernel function that can be executed is found, continues to execute the kernel function.

The core that has been determined in block 150 as not being a representative core switches between the state of waiting for execution of the kernel function (block 140) and the state of executing the kernel function (block 142).

When it is determined in block 106 that the bytecode is not a kernel function, the bytecode is executed in block 122, the program counter is incremented in block 124, and the procedure returns to block 104.

Thus, the core block with block ID 0 of the computing device 14 reads the bytecode, executes the interpreter, generates a task management structure when a kernel function that can be executed is found, secures core blocks of a number necessary for executing the kernel function, inherits the processing of the interpreter to the next core block, and starts execution of the kernel function together with the thread corresponding to the secured core blocks. When not all the data on the arguments of the kernel function has been computed (i.e., when the bytecode corresponding to the kernel function cannot be executed), data necessary for the task management structure is added, and execution of the bytecode is continued. The core block that has inherited the processing of the interpreter performs an operation similar to that of the first core block.

In the embodiment, seamless parallel processing of the host CPU/computing device is achieved by converting the parallel code into the bytecode, but when the processing is performed only in the computing device, it is also possible to perform the processing by converting the parallel code not into the bytecode but into a specific data structure.

As described above, according to the first embodiment, by associating the return value of the previous kernel function with the argument of the subsequent kernel function on the device memory and defining a task management structure representing the sequence of the execution of the kernel functions, the computing device is capable of appropriately allocating the kernel functions to the core blocks in the computing device and executing the kernel functions in parallel, thereby bringing out the maximum parallelism during program execution.

Since the computing device autonomously controls the order of execution of the kernel functions without intervention of the host CPU, a high level of performance is achieved by utilizing the computing device efficiently, even if a computing device supports only the API of the SPMD or in an algorithm in which data parallelism is not sufficient.

Even in a complex algorithm that does not reach the degree of parallelism required by the computing device, it is possible to prevent occurrence of timing bugs caused by parallel processing and to increase efficiency of use of the computing device by means of parallel task processing.

The present invention is not limited to the above-described embodiment, and may be embodied with modifications to the constituent elements within the scope of the invention. Further, various inventions can be made by appropriately combining the constituent elements disclosed in the embodiment. For example, some of the constituent elements may be omitted from all the constituent elements disclosed in the embodiment. Moreover, the constituent elements disclosed in different embodiments may be combined as appropriate.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus, comprising:
a processor comprising a plurality of core blocks; and
a memory connected to the processor and configured to store a command queue and task management structure data,
wherein the command queue is configured to store a series of kernel functions formed by combining a plurality of kernel functions, the task management structure data is configured to define an order of execution of kernel functions by associating a return value of a previous kernel function with an argument of a subsequent kernel function, and core blocks of the processor are capable of executing different kernel functions.

2. The apparatus of claim 1, wherein the command queue comprises an entry address of the series of kernel functions, an interpreter being placed in the entry address.

3. The apparatus of claim 2, wherein a predetermined core of each of said plurality of core blocks is configured to execute the interpreter and a remaining core is configured to repeatedly switch between a state of waiting for execution of a kernel function and a state of executing a kernel function.

4. The apparatus of claim 3, wherein when the interpreter reads the kernel function, a predetermined core of a predetermined core block of said plurality of core blocks is configured to add data on the kernel function to the task management structure data, to secure core blocks of a number necessary for execution of the kernel function, and to inherit processing of the interpreter to a next core block.

5. The apparatus of claim 4, wherein when the argument of the kernel function read by the interpreter has not been computed, said predetermined core of said predetermined core block is configured to be set in a state of waiting for execution of the kernel function.

6. A data processing method of a data processing apparatus comprising a processor formed of a plurality of core blocks and a memory connected to the processor, the method comprising:
setting a series of kernel functions formed by combining a plurality of kernel functions in a command queue provided in the memory; and
storing task management structure data in the memory, the task management structure data defining an order of execution of kernel functions by associating a return value of the previous kernel function with an argument of the subsequent kernel function,
wherein the core blocks of the processor are capable of executing different kernel functions.

7. The method of claim 6, further comprising:
setting an interpreter in an entry address of the series of kernel functions set in the command queue.

8. The method of claim 7, further comprising:
execute the interpreter by a predetermined core of each of said plurality of core blocks; and
repeatedly switching a remaining core between a state of waiting for execution of a kernel function and a state of executing a kernel function.

9. The method of claim 8, further comprising:
adding data on the kernel function to the task management structure data by a predetermined core of a predetermined core block of said plurality of core blocks when the interpreter reads the kernel function;
securing core blocks of a number necessary for execution of the kernel function; and
inheriting processing of the interpreter to a next core block.

10. The method of claim 9, further comprising:
setting said predetermined core of said predetermined core block in a state of waiting for execution of the kernel function when the argument of the kernel function read by the interpreter has not been computed.
